(19) United States
(12) Patent Application Publication
(10) Pub. No.: US 2008/0307367 A1
(43) Pub. Date: Dec. 11, 2008

(54) METHOD AND APPARATUS FOR A DRAG AND DROP OPERATION IMPLEMENTING A HIERARCHICAL PATH NAME

(76) Inventors: John Michael Garrison, Austin, TX (US); Michael S. McKay, Round Rock, TX (US)

Correspondence Address: IBM CORP (YA);C/O YEE & ASSOCIATES PC, P.O. BOX 802333, DALLAS, TX, 75380, US

(21) Appl. No.: 11/759,371

(22) Filed: Jun. 7, 2007

(51) Int. Cl. G06F 3/048

(52) U.S. Cl. 715/853; 715/841; 715/856

(57) ABSTRACT

A computer implemented method, apparatus, and computer program product for transferring a file item. The process selects a file item in response to receiving a first input command. The process selects a file item in response to receiving a first input command. The process then identifies a file path name from a hierarchical file path to form a selected file path name. The file path name is identified by detecting a pointer passing over the file path name. In response to receiving a second input command, the process transfers the file item to a storage location associated with the selected file path name.

### BACKGROUND OF THE INVENTION

1. Field of the Invention

The present invention relates generally to an improved data processing system, and in particular, to a computer implemented method and apparatus for a drag and drop file transfer operation. Still more particularly, the present invention relates to a computer implemented method, apparatus, and computer usable program product for enabling a drag and drop operation by interacting with a hierarchical path name displayed in the address field of a file manager browser.

2. Description of the Related Art

A “drag and drop” file transfer operation is a method of transferring a file item from one storage location to another. A file item is any type of computer file used by or stored in a computer system. A file item may be, for example, system or program files, user generated files or documents, audio or video files, and directories that may or may not include subdirectories and additional computer files.

In order to perform the drag and drop operation, a user may utilize a file manager browser to locate the file item. A file manager browser is a software application that provides the user with a graphical user interface in order to navigate a computing device's file system to locate the file item. A file system is a construct of the computing device implemented for the storage, hierarchical organization, manipulation, navigation, access, and retrieval of computer files and the data contained therein.

To perform the drag and drop operation on the located file item, a user may select the file item by moving a mouse pointer over a file item and pressing a button on the mouse or other input device to “grab” the object. The file item is then “dragged” to another storage location by operating the mouse to position the selected file item over a target storage location. Subsequently, the user “drops” the file item into the new storage location by releasing the depressed button.

This current method of transferring file items from one storage location to another can be unnecessarily time consuming and burdensome. For example, a user may be required to execute a first file manager browser to locate the file item. The user may then be required to execute a second file manager browser to locate a target storage location to which the file item is to be transferred. Thereafter, the user may be required to resize the file manager browser windows to properly display both browsers, so that the drag and drop operation can be performed.

### SUMMARY OF THE INVENTION

The illustrative embodiments described herein provide a computer implemented method, apparatus, and computer usable program product for transferring a file item. The process selects a file item in response to receiving a first input command. The process selects a file item in response to receiving a first input command. The process then identifies a file path name from a hierarchical file path to form a selected file path name. The file path name is identified by detecting a pointer passing over the file path name. In response to receiving a second input command, the process transfers the file item to a storage location associated with the selected file path name.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a diagram of components for use in performing a drag and drop operation in accordance with an illustrative embodiment;

FIG. 4 is a screenshot of a file manager browser in accordance with an illustrative embodiment; and

FIG. 5 is a flowchart of a process for managing the drag and drop operation in accordance with an illustrative embodiment.

### DETAILED DESCRIPTION OF THE PREFERRED EMBODIMENT

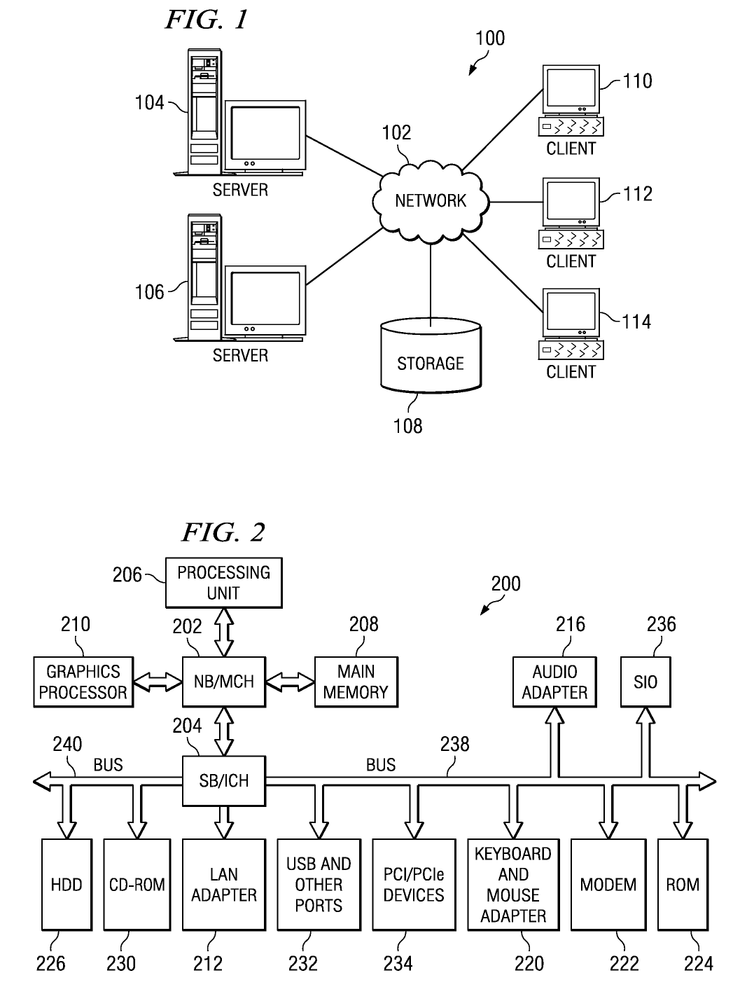

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer usable program product for transferring a file item. The process selects a file item in response to receiving a first input command. The process selects a file item in response to receiving a first input command. The process then identifies a file path name from a hierarchical file path to form a selected file path name. The hierarchical file path is an address of the file item that specifies the file item's storage location. In particular, the hierarchical file path is a series of one or more file path names of any directory and/or subdirectories in which the file item is located. A file path name is an alphanumeric string of text that corresponds to the name of a directory. The file path names may be segregated by a slash. For example, an audio file may be stored in a hard disk drive of a laptop computer. The hierarchical file path of the audio file may be C:\Documents and Settings\User Name\My Documents\My Music\Audio File. In this example, the plurality of file path names includes the C: directory, and the following subdirectories: Documents and Settings, User Name, My Documents, and My Music.

The file path name is identified by detecting a pointer passing over the file path name. A pointer is a graphical indicator that is used to identify a point at which a user may manipulate objects displayed on a graphical user interface. A pointer may be used to select objects and perform actions on the selected objects. The actions include, without limitation, a drag and drop operation, a delete operation, a copy operation, and a paste operation. For example, in a drag and drop operation, the pointer may be the file item selected for transfer. In a copy and paste operation, the pointer may be a user-operated cursor, such as a mouse cursor.

In response to receiving a second input command, the process transfers the file item to a storage location associated with the selected file path name. A storage location is a location in a computing device to which a file item may be saved. For example, the storage location may refer to a block of memory in a hard disk drive of a computing device on which the file item was created or modified. The storage location may also refer to a directory within the operating system of the computing device. In addition, the storage location may refer to a physical device in which the file item may be stored, such as a removable universal serial bus storage device coupled to the computing device.

In addition, a user may also transfer the file item to a subdirectory of a selected file path name by causing the file item to hover over the selected file path name. The hovering file item causes the process to display a menu for presenting to a user the subdirectories located within the selected file path name. Consequently, a user may transfer the file item to any subdirectory in the hierarchical file path. Further, depending upon the particular implementation of the invention, the drag and drop transfer operation may move one file from a first storage location to a second storage location, or may simply transfer a copy of the file item to a second storage location, maintaining the original copy of the file item in the original storage location.

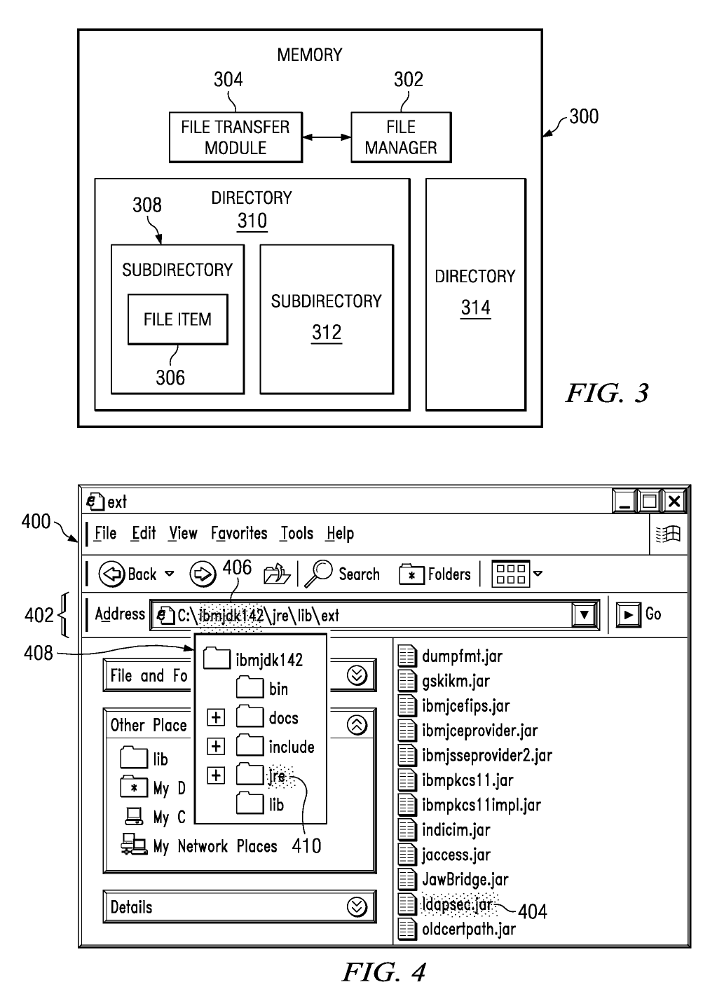

Turning now to FIG. 3, a diagram of components for use in a drag and drop operation is depicted in accordance with an illustrative embodiment. Memory 300 is a memory component such as HDD 226 in FIG. 2. In alternate embodiments, memory 300 may be any form of memory capable of retaining data, such as flash memory.

File manager 302, which is stored in memory 300, is a software application that works in conjunction with file transfer module 304 to allow a user to access and utilize a computing device's file system. When executed, file manager 302 provides the user with a graphical user interface to interact with the file system. File manager 302 may be, for example, Windows® Explorer®. Windows is a trademark of Microsoft Corporation in the United States, other countries, or both, and is available from Microsoft Corporation.

In this illustrative example in FIG. 3, a user executes file manager 302 in order to access a file manager browser to manage computer files. The computer files are represented herein by file item 306. File item 306 is stored in subdirectory 308. Subdirectory 308 is stored in directory 310. In this example, where memory 300 is a hard disk drive designated as, for example, a C: drive of a computing device, the hierarchical file path corresponding to file item 306 may be displayed in an address bar of a file manager browser as follows: C:\directory 310\subdirectory 308\file item 306. In the depicted example, subdirectory 308, directory 310, and the C: root directory are file path names that, when combined, form the hierarchical file path identifying the storage location of file item 306. Each file path name is an alphanumeric string of text that represents a directory or subdirectory that may have within it any number of subdirectories and computer files.

In this example in FIG. 3, file transfer module 304 facilitates the transfer of file item 306 by allowing a user to interact with the hierarchical file path in the address bar of a file manager browser. In particular, file transfer module 304 allows the user to drop file item 306 into a storage location by interacting with the hierarchical file path in the address bar of file manager 302 rather than having to open up a second file manager browser. For example, a user may operate an input device, such as a computer mouse, to select file item 306 for transfer. File transfer module 304 receives a first input command from the user operating the mouse. In this instance, the first input command detected by file transfer module 304 is the pressing and holding of a mouse button. Upon receiving this first input command, file transfer module 304 selects file item 306 for transfer. The user may then drag file item 306 to the address bar of file manager 302.

When file transfer module 304 detects that a user has moved file item 306 to a position over a file path name of the hierarchical file path corresponding to file item 306, file transfer module identifies that file path name as the selected file path name. File transfer module 304 may cause file path name to be highlighted, bolded, set out in a larger font size, or rendered in another conspicuous way to alert the user that the user has selected a particular file path name.

If the user desires to transfer file item 306 to a directory represented by one of the file path names that forms the hierarchical file path of file item 306, then, in this example, the user simply releases the mouse button over the selected file path name. File transfer module 304 receives this second input command and transfers file item 306 to the directory corresponding to the selected file path name.

In other implementations, the first input command for selecting a file item for transfer may be a single click and release of a button on the input device. Similarly, the second input command for causing the transfer of the file item may be a subsequent click and release. Furthermore, the first input command may be a “copy” command or “cut” command, and the second input command may be a “paste” command. In these instances, the selected file path name is identified when file transfer module 304 detects that the user-controlled cursor has traveled over a selected file path name.

A user may also easily transfer file item 306 to a subdirectory maintained within the selected file path of the hierarchical file path. To accomplish this transfer, the user may cause file item 306 to hover over the selected file path name. Once file transfer module 304 detects that file item 304 is hovering over the selected path name, file transfer module 304 displays a menu containing the subdirectories within the selected file path name. The subdirectories may be displayed to the user in any number of ways, such as in a popup tree or a drop down menu. In any event, once the subdirectories are displayed, the user may transfer file item 306 to a subdirectory.

If the subdirectory of the selected file path name has within it additional subdirectories, the user can reveal those subdirectories by causing file item 306 to hover over the subdirectory in the manner described above. Thereafter, the user can complete the drag and drop operation to transfer file item 306 to a subdirectory within the selected file path.

A user may also transfer file item 306 to a subdirectory within subdirectory 308, directory 310, or memory 300 by causing file item 306 to hover over a selected file path rather than immediately dropping file item 306 to a storage location represented by the selected file path. Upon detecting that a user has caused file item 306 to hover over a selected file path name, file transfer module displays a menu of subdirectories contained within the selected file path name.

Thus, if a user desires to transfer file item 306 to a different subdirectory within directory 310, such as subdirectory 312, then the user may drag file item 306 to a position over the file path name corresponding to directory 310 and cause file item 306 to hover over the selected file path name. File transfer module 304 will display a menu including subdirectory 308 and subdirectory 312. Thereafter, the user can drop file item 306 into subdirectory 312.

Using the above-mentioned method, a user can also transfer file item 306 to a directory separate from the original hierarchical file path of file item 306. For example, the user can transfer file item 306 to directory 314 by dragging file item 306 to the file path name corresponding to memory 300. In response to detecting file item 306 hovering over the file path name for memory 300, file transfer module 304 displays a menu including directory 314.

Although in this illustrative example, file transfer module 304 is depicted as a separate software component from file manager 302, in an alternate embodiment, file transfer module 304 may be a portion of code integrated in the software code for file manager 302.

Turning now to FIG. 4, a screenshot of a file manager browser is depicted in accordance with an illustrative embodiment. File manager browser 400 is a file manager browser, such as the file manager browser presented to a user upon execution of file manager 302 in FIG. 3. File manager 400 includes address bar 402 for displaying a hierarchical file path of file item 404. File item 404 is a file item such as file item 306 in FIG. 3.

In FIG. 4, file item 404 is one of a collection of file items in a subdirectory. After selecting file item 404 by manipulating an input device to generate a first input command, a user may then drag file item 404 to address bar 402. For example, file item 404 may be selected by pressing and holding a button on a mouse. By causing file item 404 to hover over file path name 406 of the hierarchical file path, the user has caused a file transfer module to display menu 408. Menu 408 is a list of subdirectories within file path 406. Thereafter, the user can drop file item 404 in a subdirectory within menu 408, such as subdirectory 410, by generating a second input command. In this example, the second input command may be the release of the depressed mouse button.

Although the example depicted in FIG. 4 depicts the root directory of the hierarchical file path as the C: directory, in another embodiment, the root may correspond to the highest level root directory available. Thus, in a computing system running Windows® Operating System, for example, the root directory of the hierarchical file path may be the “My Computer” directory.

Consequently, a user desiring to transfer file item 306 to a storage location that is located on a different storage device than the one that originally stored file item 306, the user may cause file item 306 to hover over the “My Computer” file path name to display all the local hard drives within the local computer system, all removable storage devices, and all network directories accessible to the computer operated by the user. Thereafter, the user may transfer file item 306 to any number of accessible storage locations.

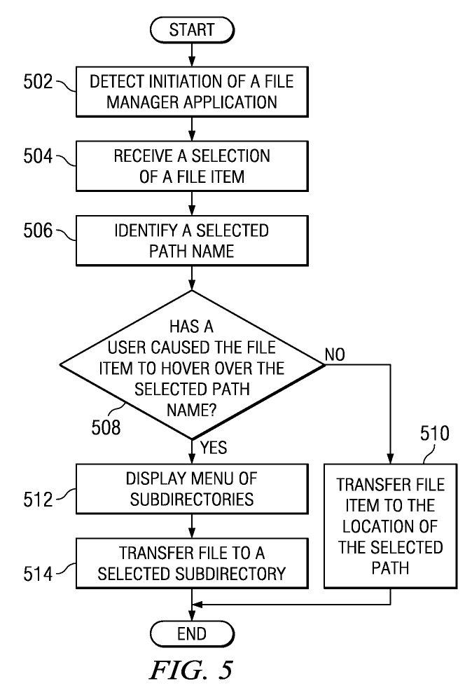

Turning now to FIG. 5, a flowchart of a process for managing the drag and drop operation is depicted in accordance with an illustrative embodiment. In this illustrative embodiment of FIG. 5, the process may be performed by a software component, such as file transfer module 304 in FIG. 3.

The process begins by detecting the initiation of a file manager application (step 502). The process then receives a first input command signaling the selection of a file item (step 504). Subsequently, the process identifies a selected path name (step 506). Thereafter, the process makes the determination as to whether a user has caused the file item to hover over the selected file path name (step 508).

If the process makes the determination that the user has not caused the file item to hover over the selected file path name, then the process transfers the file item to a storage location corresponding to the selected file path name in response to receiving a second input command (step 510). The process terminates thereafter.

However, if the process makes the determination that a user has caused the file item to hover over the selected file path name, then the process displays a menu containing the subdirectories maintained within the selected file path name (step 512). Thereafter, the process transfers the selected file item to a target directory or subdirectory (step 514), and the process terminates.

The flowcharts and block diagrams in the different depicted embodiments illustrate the architecture, functionality, and operation of some possible implementations of methods, apparatus, and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the illustrative embodiments described herein provide a computer implemented method, apparatus, and computer usable program product for transferring a file item. The process selects a file item in response to receiving a first input command. The process selects a file item in response to receiving a first input command. The process then identifies a file path name from a hierarchical file path to form a selected file path name. The file path name is identified by detecting a pointer passing over the file path name. In response to receiving a second input command, the process transfers the file item to a storage location associated with the selected file path name.

Using the method and apparatus disclosed herein, a user attempting to transfer a file item from one storage location to another storage location can easily perform this transfer without having to spend unnecessary time opening a first file manager browser window to locate the file item, open a second file manager browser corresponding to the new location for the file item, resize the file manager browsers, and then perform the drag and drop transfer operation. Instead, the user can now select the file item designated for transfer and drag the file item to a file path name in the address bar to transfer the file item without having to execute additional file manager browsers. A user causing the file item to hover over a file path name causes a drop menu of directories and subdirectories, if any. The user can then easily drop the file item into the desired directory.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for transferring a file item, the computer implemented method comprising:
responsive to receiving a first input command, selecting the file item;
identifying a file path name from a hierarchical file path to form a selected path name, wherein the hierarchical file path is an address of the file item, and wherein the file path name is identified by detecting a pointer passing over the file path name; and
responsive to receiving a second input command, transferring the file item to a storage location associated with the selected path name.

2. The computer implemented method of claim 1, wherein the pointer is the file item.

3. The computer implemented method of claim 1, wherein the pointer is a cursor.

4. The computer implemented method of claim 1, wherein the selected path name is identified by highlighting the selected path name.

5. The computer implemented method of claim 1, wherein the identifying step further comprises:
responsive to detecting the file item hovering over the selected path name, displaying a menu associated with the selected path name, wherein the menu contains a set of subdirectories.

6. The computer implemented method of claim 1, wherein the hierarchical file path of the file item is located in an address bar of a file manager browser.

7. A computer program product comprising:
computer usable program code for transferring a file item, the computer program product method comprising:
computer usable program code for selecting the file item in response to receiving a first input command;
computer usable program code for identifying a path name from a plurality of hierarchical path names to form a selected path name, wherein the plurality of hierarchical path names is an address of the file item, and wherein the file path name is identified by detecting a pointer passing over the file path name; and
computer usable program code for transferring the file item to a storage location associated with the selected path name in response to receiving a second input command.

8. The computer program product of claim 7, wherein the pointer is the file item.

9. The computer program product of claim 7, wherein the pointer is a cursor.

10. The computer program product of claim 7, wherein the selected path name is identified by highlighting the selected path name.

11. The computer program product of claim 7, wherein the identifying step further comprises:
computer usable program code for displaying a submenu associated with the selected path name, wherein the submenu contains a set of subdirectories in response to detecting the file item hovering over the selected path name.

12. The computer program product of claim 7, wherein the address of the file item is located in an address bar of a file manager browser.
